(19) United States
(12) Patent Application Publication
(10) Pub. No.: US 2016/0280037 A1
(43) Pub. Date: Sep. 29, 2016

(54) STABILIZER LINK

(71) Applicant: TOYOTA MOTOR ENGINEERING & MANUFACTURING NORTH AMERICA, INC., Erlanger, KY (US)

(72) Inventors: Kyle G. STEINKAMP, Ann Arbor, MI (US); Jakin C. Wilson, Phoenix, AZ (US)

(73) Assignee: TOYOTA MOTOR ENGINEERING & MANUFACTURING NORTH AMERICA, INC., Erlanger, KY (US)

(21) Appl. No.: 14/665,974

(22) Filed: Mar. 23, 2015

(51) Int. Cl. B60G 21/055

(52) U.S. Cl. CPC B60G 21/0551

(57) ABSTRACT

A suspension stabilizer endlink, affixed to a stabilizer bar and a vehicle suspension arm or strut, comprising a contoured shape and varying in size along the length of the endlink, with the largest cross-sectional area provided in the middle portion of the endlink and the smallest cross-sectional area provided at the ends of the endlink.

### BACKGROUND

1. Field of the Disclosure

The present disclosure relates to suspension stabilizer systems.

2. Description of the Related Art

Primary goals of vehicle suspension design may include optimizing individual tire traction, achieving a reasonable balance between all the tires, and arriving at an acceptable compromise between ride comfort and vehicle stability within a given cost constraint. One design consideration for four-wheeled vehicles is the degree of lateral weight transfer as the vehicle turns, and how to control that transfer as part of the vehicle design process.

As a four-wheeled vehicle, for example an automobile, turns weight is transferred from the inside to the outside tires. Assuming equal static side-to-side weight distribution, more of a vehicle's weight is distributed over the left side tires as the vehicle travels through a right hand turn, and vice versa. The relationship of how much weight or vertical load is transferred from the tires of one side of the vehicle to the tires on the other side for a given turn is a function of many interrelated factors. Among them are vehicle chassis rigidity, suspension geometry and rigidity, instantaneous vehicle speed, roll center height, and the location of the vehicle's center of gravity.

Furthermore, the relative stiffness between the front and rear suspension will strongly influence the amount of weight that is transferred from side to side as well as between the front and rear tires. As weight is transferred from the tires of one side to the tires on the other side of the vehicle, the vehicle tends to lean or roll about its longitudinal axis which intersects the vehicle center of gravity. For a given vehicle, the greater the amount of weight that is transferred, the greater the magnitude of body roll.

As the vehicle turns, the center of gravity experiences a centrifugal force orthogonal to the path of travel of the vehicle's center of gravity. This centrifugal force is counteracted by the sum of the available lateral forces in each tire. If the centrifugal force of the center of gravity exceeds the available lateral force in the tires the driver will experience a loss of control as some or all of the tires begin to slide laterally. A key point is that the amount of lateral force a tire produces is proportional to the vertical load applied, within a given operating range.

Further, because the vehicle center of gravity is above the ground plane and usually not located at the suspension roll center, the force at the center of gravity creates a moment or torque about the roll center of the suspension at each end of the vehicle. This moment is the roll couple. The greater the cornering speed of the vehicle and the smaller the radius of the turn, the greater the magnitude of the roll couple, and the greater the magnitude of vehicle body roll.

In general vehicle body roll has the undesirable effect of reducing a vehicle's maximum cornering ability by increasing the amount of vertical load transferred from the inside tires to the outside tires, reducing a vehicle's total lateral traction limit. For a given set of conditions, a loss of control generally occurs sooner in a vehicle that exhibits a high degree of body roll.

The theoretical maximum amount of traction available to the vehicle occurs when the sum of the vertical load on each of the four tires is at its maximum. Lateral weight transfer reduces the vertical load on the inside tires while increasing the load on the outside tires. This is undesirable for two reasons. One is that the lateral traction produced by the inside tires is less than their maximum potential due to the reduction in their vertical loads. Secondly, the increase in vertical loads on the outside tires may exceed their operating capacity, also reducing the amount of lateral traction available from the outside tires. The total amount of lateral traction available is thus decreased. Therefore reducing lateral weight transfer maximizes overall vehicle traction for a given set of conditions.

Stabilizer bars are designed to limit the amount of lateral weight transfer on a vehicle suspension to increase the speed and stability at which a vehicle can travel around a curved path.

Stabilizer bars are generally comprised of bars or tubes connected to opposite side struts or suspension control arms through endlinks.

The stabilizer bar effectively serves as a torsion spring mounted to the vehicle chassis, with a lever arm on each end connected to an endlink connected to a vehicle control arm or strut at the other end of the endlink on each side of the vehicle. Vertical movement of one wheel transmits a force through the nearest endlink then to the nearest lever arm, which applies a torque to the stabilizer bar. That torque is transmitted through the stabilizer bar to the lever arm on the opposite end of the stabilizer bar, providing force to the corresponding endlink, and when in roll, applying an equal and opposite force to the wheel opposite of the wheel that was initially displaced vertically.

### SUMMARY

The present disclosure is directed to a vehicle suspension stabilizer bar endlink optimized for bending stiffness through the use of contoured cross sections. A contoured endlink shape provides for improved bending stiffness while minimizing mass compared with an endlink that is not contoured. The result of using stabilizer bars with endlinks of contoured shape and varying cross sections, according to the present disclosure, is the ability to more precisely design and tune vehicle handling because there is less uncontrolled flexing and deflection of suspension components. Vehicle testing has confirmed that use of contoured endlink assemblies result in greater steering efficiency and reduced response time. For a given steering torque input, a greater yaw angle output is achieved.

The forgoing general description of the illustrative implementations and the following detailed description thereof are merely exemplary aspects of the teachings of this disclosure, and are not restrictive.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein:

FIGS. 1A, 1B, and 1C are representations of the top, front, and right profile views, respectively, of an automobile chassis and suspension system equipped with a stabilizer bar and endlinks, according to certain embodiments of the disclosure.

FIG. 2 is a side view of an automobile strut assembly and a section view of a coil spring and a shock absorber, according to certain embodiments of the disclosure.

FIG. 3 is an exploded view of an embodiment of an endlink assembly comprising an endlink, a top endlink stud and ball joint, a top endlink dust cap, a bottom endlink stud and ball joint, and a bottom endlink dust cap, according to certain aspects of the disclosure.

FIG. 4 depicts the side, front and top views of an embodiment of an endlink assembly comprising an endlink, a top endlink stud and ball joint, a top endlink dust cap, a bottom endlink stud and ball joint, and a bottom endlink dust cap, according to certain aspects of the disclosure.

### DETAILED DESCRIPTION OF THE EMBODIMENTS

In the drawings, like reference numerals designate identical or corresponding parts throughout the several views. Further, as used herein, the words “a”, “an” and the like generally carry a meaning of “one or more”, unless stated otherwise. Further, numerals represent components and aspects of the right side of a vehicle with the exception of 2 and 12, of which there is only one of each, and both are also symmetrical about the vehicle. Lastly, references to components on the right side of the vehicle are designated by the letter “R” after the numeral. The drawings are generally drawn to scale unless specified otherwise or illustrating schematic structures or flowcharts.

The stiffness of the endlink is important in that any bending or deflection reduces the precision with which the suspension, and therefore the vehicle, can be controlled.

Each wheel of a vehicle equipped with a MacPherson strut-type suspension typically features a single control arm attached to a strut assembly. This generally encompasses a telescoping shock absorber, coil spring and spring perch, by way of a hub carrier to which the wheel hub, brake drum or disc, brake caliper attaches, and on driven wheels, the stub axle for the drive shaft.

The control arm and hub carrier are usually connected by spherical joints, for example ball joints which allow angular rotation in multiple directions between the control arm and the hub carrier. The MacPherson strut can be used with a variety of vehicle layouts including with front wheel drive, rear wheel drive, and all-wheel drive, whether at the front or rear suspension.

Many vehicles, including those equipped with MacPherson strut type suspensions, are equipped with stabilizer bars to provide additional ways for adjusting certain vehicle suspension traits. A primary aim of stabilizer bars is to reduce roll about the vehicle's longitudinal axis while undergoing transient maneuvers, for example while turning, by stiffening the suspension of the outside wheel without having to use stiffer suspension springs, which are detrimental to ride comfort. This is accomplished by using the drooping motion of the inside wheel to apply a torque to the stabilizer bar connecting the left and right side suspension. Transmitting that torque to the stabilizer bar endlink on the opposite side of the vehicle, applies a force to stiffen the suspension of the outside wheel to reduce body roll.

Furthermore, stabilizer bars allow each wheel in a pair to remain relatively softly sprung in bump and rebound in the interest of ride comfort over bumps while resisting roll comparable to a more stiffly sprung suspension not equipped with a stabilizer bar. For example, if both wheels on either side of a vehicle are compressed simultaneously while driving over a speed bump, stabilizer bars are designed in such a way that little or no torsion is applied to the stabilizer bar. The suspension on both wheels compresses and rebounds mostly under the control of each wheel's suspension. However, if only one wheel hits an undulation, both sides of the suspension will experience some impact due to stabilizer bar torsion.

Reducing body roll of the vehicle has a number of benefits, for example reduced lateral weight transfer and more even tire wear due to less tire camber or lean with the road surface. The design of front and rear suspensions of an automobile can utilize stabilizer bars to fine tune the relative balance between the front and rear suspension to achieve the desired handling traits.

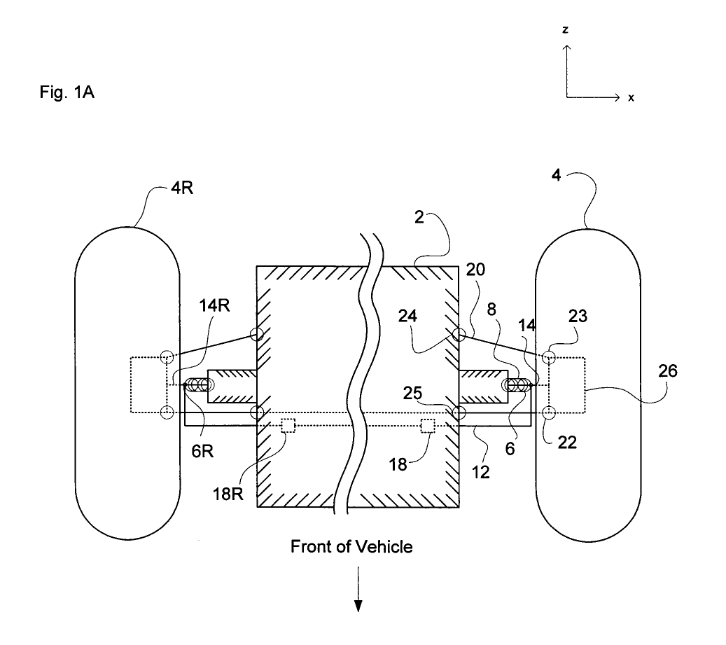

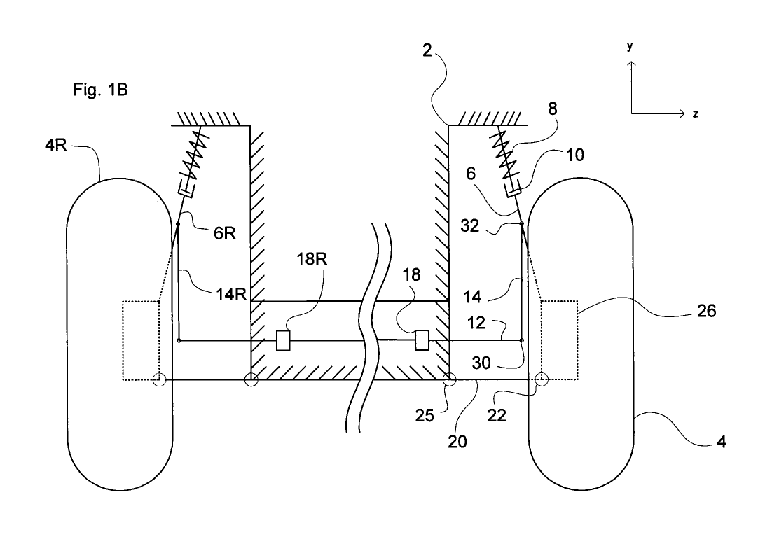

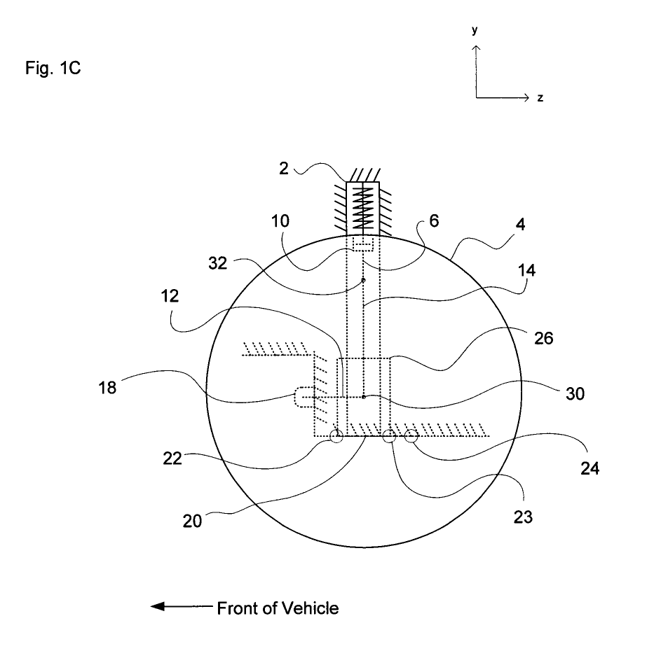

FIG. 1A depicts a top view in the x-z plane of a symmetrical and sectioned embodiment of an automobile chassis and suspension system. A vehicle chassis 2 is suspended above the ground on its left side by means of a tire and wheel assembly 4, and components described herein. The tire and wheel assembly 4 is affixed to a hub carrier 26, is disposed in a substantially vertical position, and substantially rotates about the y-z plane as the vehicle drives in a forward direction. The hub carrier 26 is also disposed in a substantially vertical position and affixed to a front outboard control arm ball joint 22, a rear outboard control arm ball joint 23, and a strut assembly 6. The front outboard control arm ball joint 22 and the rear outboard control arm ball joint 23 are also affixed to a control arm 20. The control arm 20 is a load carrying member formed from, for example, a metal stamping or casting, disposed in a substantially horizontal position in the x-z plane, and serves as a lever connecting the vehicle chassis 2 and the hub carrier 26. The control arm 20 pivots about the vehicle chassis 2 through the rotation of a rear inboard control arm ball joint 24 and a front inboard control arm ball joint 25. The tire and wheel assembly 4 and the hub carrier 26 pivot in a vertical direction about the front outboard control arm ball joint 22, the rear outboard control arm ball joint 23, and the pivoting of the strut assembly 6 as it compresses and extends. The strut assembly 6 is disposed in a substantially vertical position, and affixed at the bottom end to the hub carrier 26 and at the top end to the vehicle chassis 2. The length of the strut assembly 6 increases and decreases in proportion to the force applied by the ground surface over which the tire and wheel assembly 4 traverses.

Further, the strut assembly 6 is connected to a stabilizer bar 12 by an endlink assembly 14. The endlink assembly 14 (FIG. 1B, 1C) is equipped with a top endlink stud 32 at the top end and a bottom endlink stud and ball joint 30 at the bottom end. In the embodiment of FIG. 1A the endlink assembly 14 is disposed in a vertical direction between the strut assembly 6 and the end of the stabilizer bar 12 such that only its top endlink stud and ball joint 32 is shown. The top endlink stud and ball joint 32 is bolted to the body of the strut assembly 6 which is also bolted to the hub carrier 26. Thus the position of the top endlink stud and ball joint 32 relative to that of the hub carrier 26 is constant.

When the vehicle chassis 2 experiences roll about its center of gravity through the z-axis along its longitudinal centerline, due to the vehicle turning right, for example, a portion of the vehicle's weight is transferred onto the left side of the vehicle. This results in a decrease in the length of the strut assembly 6 as it compresses. Simultaneously, the length of the strut assembly 6R increases as tire and wheel assembly 4R droops as an equal amount of vehicle weight is transferred away from the right side of the vehicle. The amount of weight transferred onto the left side of the vehicle is greater than the weight that is supported by that same side of the vehicle under static or steady-state conditions.

The stabilizer bar 12 is affixed to the vehicle chassis 2 with stabilizer bar mounts 18 and 18R, and connected to the strut assemblies 6 and 6R using endlink assemblies 14 and 14R, respectively, to reduce lateral weight transfer from one side of the vehicle to the other. This reduces roll of the vehicle chassis 2 and reduces vertical movement of each tire and wheel assembly 4 and 4R, when the vehicle chassis 2 is subjected to the roll condition.

When the vehicle chassis 2 is subjected to the roll condition, for example in a right hand turn, the tire and wheel assembly 4 and the tire and wheel assembly 4R move in opposite vertical directions relative to the vehicle chassis 2. For example, as more vehicle weight is transferred onto the tire and wheel assembly 4, the strut assembly 6 is compressed while the same amount of vehicle weight is transferred away from the tire and wheel assembly 4R. The resulting droop of the tire and wheel assembly 4R increases the length of the strut assembly 6R.

In this condition, as the strut assembly 6 compresses and the tire and wheel assembly 4 rises relative to the vehicle chassis 2, a tensile force is applied on the endlink assembly 14, which pulls against the end of the stabilizer bar 12 on the left side of the vehicle in an upward direction. This tensile force applies a torque about the portion of the stabilizer bar 12, disposed along the width of the vehicle along the x-axis, which also resists the upward movement of the strut assembly 6, reducing the amount of weight transferred in the roll condition.

At the same time the strut assembly 6R extends and applies a compression force on the endlink assembly 14R, which pushes in a downward direction against the end of the stabilizer bar 12 on the right side of the vehicle, applying a torque about the stabilizer bar 12. Therefore the stabilizer bar 12 serves as a torsion spring resisting both the compression of the strut assembly 6 and the extension of the strut assembly 6R.

FIG. 1B depicts a front view in the x-y plane of the sectioned, symmetrical automobile chassis and suspension system equipped with the stabilizer bar 12, and one pair of each of the following components: the wheel and tire assembly 4, the hub carrier 26, the control arm 20, the front outboard control arm ball joint 22, the front inboard control arm ball joint 25, the stabilizer bar mount 18, the endlink assembly 14 comprising the endlink 28, the top endlink ball joint, and a bottom endlink balljoint, and the strut assembly 6 comprising a coil spring 8 and a shock absorber 10.

FIG. 1C depicts a right side view in the y-z plane of the automobile suspension system equipped with the wheel and tire assembly 4, the hub carrier 26, the control arm 20, the front outboard control arm ball joint 22, the rear inboard control arm ball joint 24, the rear outboard control arm ball joint 23, the stabilizer bar mount 18, the endlink assembly 14, and the strut assembly 6.

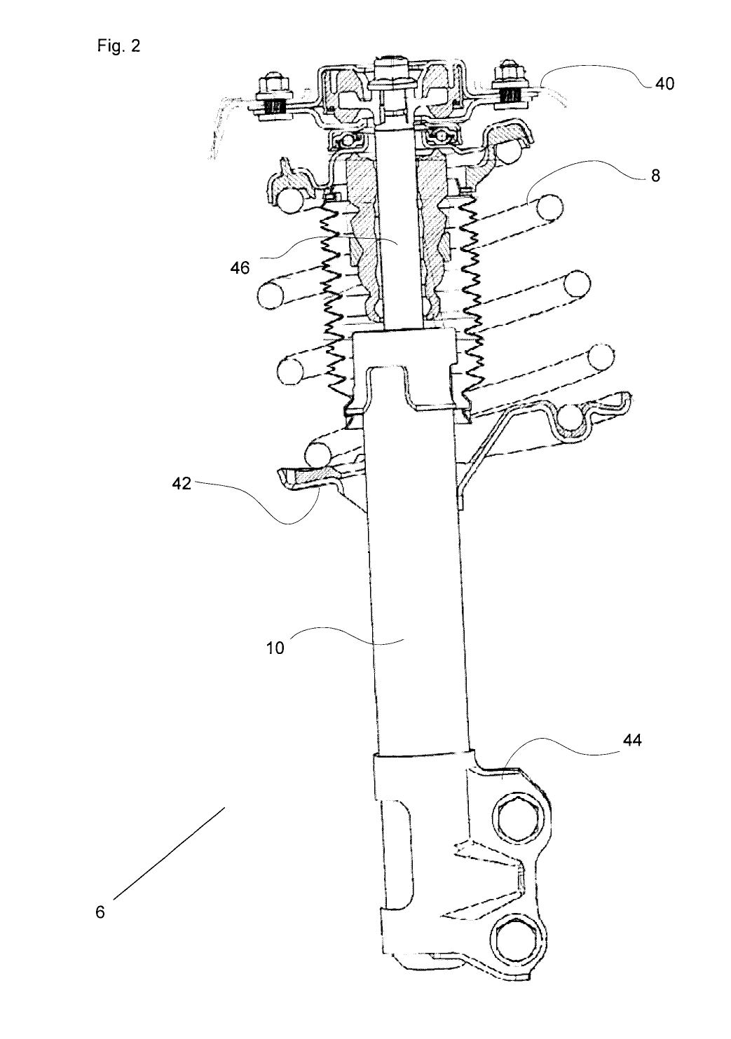

FIG. 2 depicts a side view of the automobile strut assembly 6 and a section view of the coil spring 8 and the shock absorber 10. The strut assembly 6 includes the coil spring 8, the shock absorber 10, a mounting flange 40, a spring perch 42, and a mounting bracket 44. The strut assembly 6 compresses and extends in a linear direction along the axis of its shock absorber 10.

The mounting flange 40 is affixed to a piston shaft 46 at one end of the shock absorber 10 by, for example, welding or fasteners. The spring perch 42 is attached along the length of the body of the shock absorber 10, which moves independently of the piston shaft 46.

The spring perch 42, is affixed to the body of the shock absorber and provides the surface for one end of the coil spring 8 to compress against. The mounting flange 40 serves as the other compression surface for the coil spring 8.

The coil spring 8 is disposed around the piston shaft 46 and body of the shock absorber 10. The coil spring 8 and the shock absorber 10 extend and compress simultaneously, and their axes of motion are parallel with each other.

The endlink assembly 14 for the stabilizer bar also attaches to the strut assembly 6 either at the body of the shock absorber 10 or at the mounting bracket 44 with, for example, the threaded top endlink stud and ball joint 32 and a nut.

The strut assembly 6 is installed in a vehicle by securing the mounting flange 40 to a vehicle chassis 2 with, for example, a plurality of bolts. The mounting bracket 44 is secured to the hub carrier 26 with, for example, a plurality of bolts.

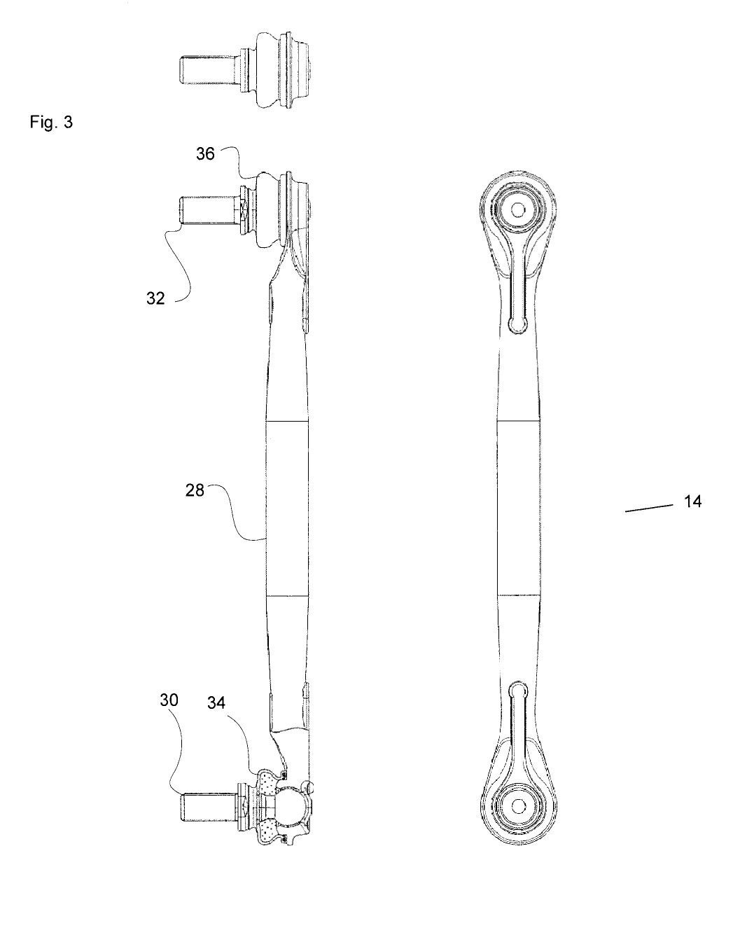

FIG. 3 depicts the side, front and top views of an embodiment of the endlink assembly 14 including the endlink 28, the top endlink stud and ball joint 32, a top endlink dust cap 36, the bottom endlink stud and ball joint 30, including a section view of the ball joint inside the bottom of the endlink 28, and a bottom endlink dust cap 34. The shape of the endlink 28 is contoured such that its cross section varies in size along its length, with the largest cross sectional area in the middle portion along the length of the endlink 28 and the smallest cross sectional area near the ends, where the shape is tapered toward the ball joints.

The threaded bottom endlink stud and ball joint 30 and the threaded top endlink stud and ball joint 32 allow appropriate securement between the stabilizer bar 12, the strut assembly 6, and the endlink assembly 14, enabling the joint of each part to pivot freely and minimizing binding as the whole assembly moves.

In the intended mounting position, the endlink 28 is subject to compression, tension, and bending stresses. The stresses are greatest toward the middle portion of the length of the endlink 28 and decrease toward the ends. The contoured shape provides for improved bending stiffness and bending rigidity while minimizing mass compared with an endlink that is not contoured or tapered.

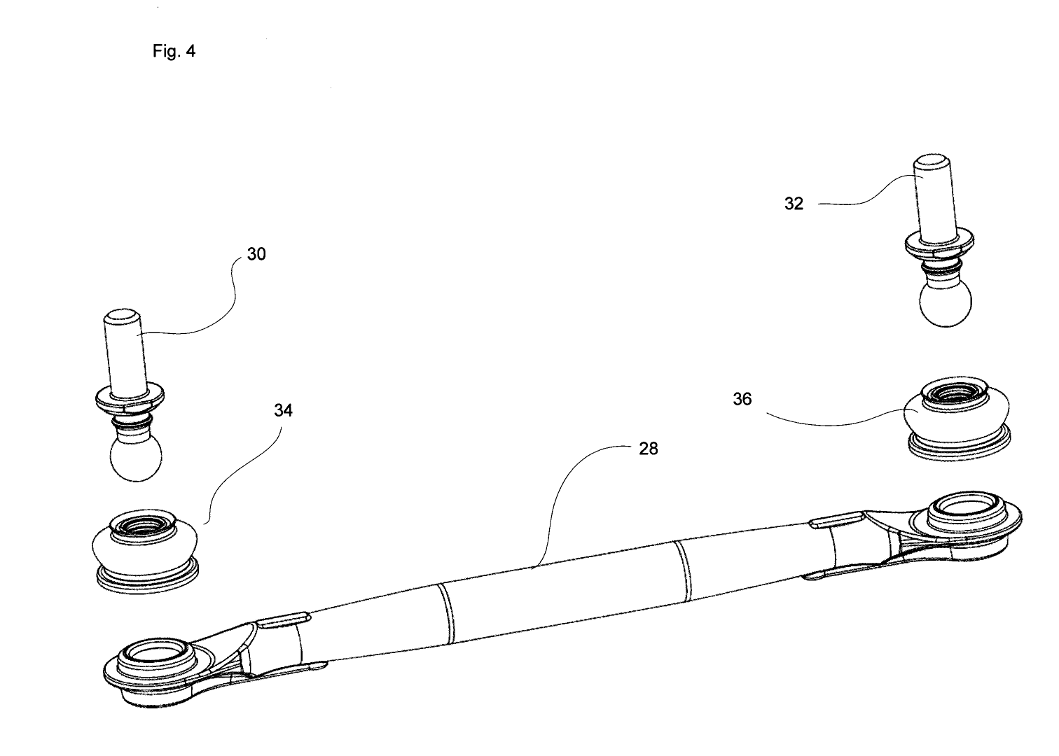

FIG. 4 is an exploded view of an embodiment of the endlink assembly 14. The endlink assembly 14, is designed for attachment to the strut assembly 6 and the stabilizer bar 12, is disposed in a substantially vertical position, and comprises two ends. The top end comprises the threaded top endlink stud and ball joint 32 and the top endlink dustcap 36. The bottom end comprises the threaded bottom endlink stud and ball joint 30, and the bottom endlink dustcap 34.

The ball joint portion of both the top endlink stud 32 and the bottom endlink stud 30 are disposed within the cavities located at each end of endlink 28. The ball joints can freely pivot, the range of motion only limited by contact of the threaded endlink studs with the sides of the endlink 28 and the top endlink dust cap 36 and the bottom endlink dust cap 34.

Furthermore, some stabilizer bar system embodiments can be adjusted, providing a range of stiffness settings, for example, by varying the effective length of the lever arms of the stabilizer bar 12, the effective and actual length of the endlink assemblies 14, the effective length of the stabilizer bar 12, the mounting angle of incidence the endlink assemblies 14 form with the stabilizer bar 12, and the diameter, shape or orientation of the stabilizer bar 12. Strut assembly 6 and stabilizer bar 12 embodiments with multiple mounting points on each lever arm allow endlink assemblies 14 to be mounted at different positions, varying both the effective lever arm length of the stabilizer bar 12 and the mounting angle of the endlink assemblies 14. Stiffness of the stabilizer bar system is proportional to the length of the effective lever arm the stabilizer bar 12 forms with the endlink assembly 14 on each side of the vehicle suspension, with the stiffest setting where the effective lever arm length is shortest.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernable variants of the teachings herein, define, in part, the scope of the foregoing claim terminology such that no inventive subject matter is dedicated to the public.

I claim:

1. A vehicle chassis suspension stabilizer system comprising:
two strut assemblies, one disposed on each side of a vehicle chassis;
a stabilizer bar; and
stabilizer bar mounts,
wherein each stabilizer bar mount includes bushings affixed to the vehicle chassis through which the stabilizer bar rotates freely and two stabilizer bar endlink assemblies, one stabilizer bar endlink assembly disposed on each side of the vehicle chassis, the endlink assemblies having a contoured shape.

2. The system of claim 1 wherein the endlink assembly comprises:
an endlink;
a ball joint in the socket at each end of the endlink; and
a threaded stud affixed to each ball joint,
wherein one threaded stud attaches to the stabilizer link with a nut, and the other threaded stud at the other end of the endlink assembly attaches to one strut assembly with a threaded fastener.

3. The system of claim 2 wherein the endlink assembly comprises:
a dust cap affixed over each ball joint and socket of the endlink to protect the ball joint from debris.

4. The system of claim 1 wherein the endlink assemblies comprise:
a stabilizer endlink having a cross-section which varies in size along the length of the endlink with the largest cross-sectional area provided in the middle portion of the endlink and the smallest cross-sectional area provided at the ends of the endlink.

5. The system of claim 1 wherein the stiffness of the stabilizer bar is not adjustable.

6. The system of claim 1 wherein the stiffness of the stabilizer bar is adjustable.
